(19) United States
(12) Patent Application Publication
(10) Pub. No.: US 2025/0231051 A1
(43) Pub. Date: Jul. 17, 2025

(54) DISPLAY DEVICE AND MEASURING INSTRUMENT

(71) Applicant: DMG MORI CO., LTD., Nara (JP)

(72) Inventors: Shingo SEKISAWA, Kanagawa (JP); Hideo MAEJIMA, Kanagawa (JP); Toyohiko MATSUDA, Kanagawa (JP)

(73) Assignee: DMG MORI CO., LTD., Nara (JP)

(21) Appl. No.: 18/705,412

(22) PCT Filed: Sep. 1, 2023
(86) PCT No.: PCT/JP2023/032045

§ 371 Date: Apr. 26, 2024

(30) Foreign Application Priority Data
Sep. 9, 2022 (JP) 2022-143588

(51) Int. Cl. G01D 7/00; G01D 13/02

(52) U.S. Cl. CPC G01D 7/00; G01D 13/02; G01D 2207/30

(57) ABSTRACT

A display device includes a display unit having a first area for displaying measurement values and a second area for displaying a plurality of icons, and a display control unit for controlling the display of images on the display unit. The display control unit performs the controls of (i) displaying, on the display unit, a first image including the measurement values in the first area and an icon image of a rotation button in the second area, and (ii) when the rotation button is touched, drawing a second image including a representation of the measurement values corresponding to a state in which the measurement values in the first image are rotated in the first region.

### TECHNICAL FIELD

This invention relates to image display technology and more particularly to image display technology in measuring instruments.

### BACKGROUND ART

Measuring instruments, such as dial gauges, are equipped with physically displaceable sensor members called spindles and levers. A dial gauge indicates the displacement amount of the sensor member by means of a pointer. Patent Literature 1 describes a measuring instrument capable of displaying the displacement amount of a spindle as an image.

### RELATED ART LIST

Patent Literature 1: JP 2013-185990 A

### SUMMARY

### Technical Problem

A measuring instrument can be used with the spindle oriented horizontally or vertically. In the dial gauge of Patent Literature 1, the image display direction can be rotated by touching a switch button (see FIGS. 1 and 2 in Patent Literature 1). However, because Patent Literature 1 uses a display method that rotates the entire image, the position of the button when the gauge is used in a horizontal orientation differs from the position of the button when the gauge is used in a vertical orientation. This means that operability varies greatly depending on the orientation of the measuring instrument.

### Solution to Problem

A display device that displays measurement values in an aspect of the present invention includes a display unit with a touch panel having a first area for displaying measurement values and a second area for displaying a plurality of icons, and a display control unit that controls the display of images on the display unit.

The display control unit performs the controls of (i) displaying, in the display unit, a first image including the measurement values in the first area and an icon image of a rotation button in the second area, and (ii) when the rotation button is touched, drawing a second image including a representation of the measurement values corresponding to a state in which the measurement values in the first image are rotated in the first region.

The present invention provides a display device and a measuring instrument as described in the claims.

### Advantageous Effects of Invention

The present invention can maintain visibility and operability even when the orientation of the display device, measuring instrument, or the like is changed.

### BRIEF DESCRIPTION OF DRAWINGS

FIG. 1A is a top view of a measuring instrument. FIG. 1B is a front view of the measuring instrument. FIG. 1C is a side view of the measuring instrument.

FIG. 2 is a perspective view of the measuring instrument.

FIG. 3 is a functional block diagram of the measuring instrument.

FIG. 4 is a screen view of the first screen.

FIG. 5 is an example of a screen view of the second screen.

FIG. 6 is another example of a screen view of the second screen.

FIG. 7 is a schematic diagram to explain the display switching when the measuring instrument is oriented horizontally.

FIG. 8 is a screen view of the third screen.

FIG. 9 is a schematic illustration of the display switching when the measuring instrument is turned upside down.

FIG. 10 is a schematic diagram showing an example of the arrangement of two measuring instruments when measuring the flatness of a workpiece.

FIG. 11A is a top view of a display device. FIG. 11B is a front view of the display device. FIG. 11C is a side view of the display device.

### DESCRIPTION OF EMBODIMENTS

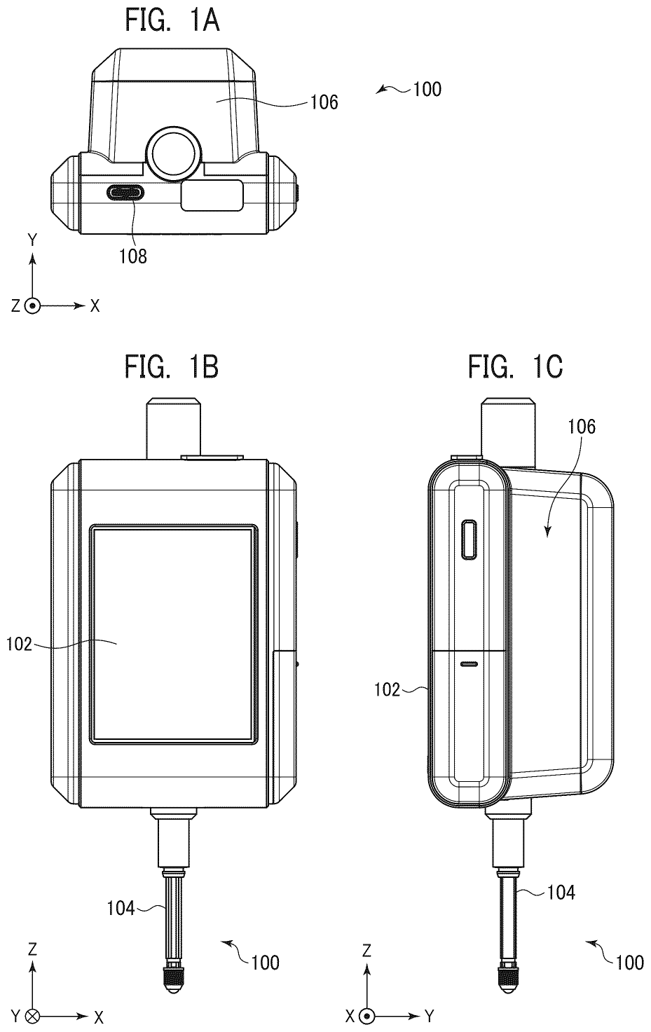

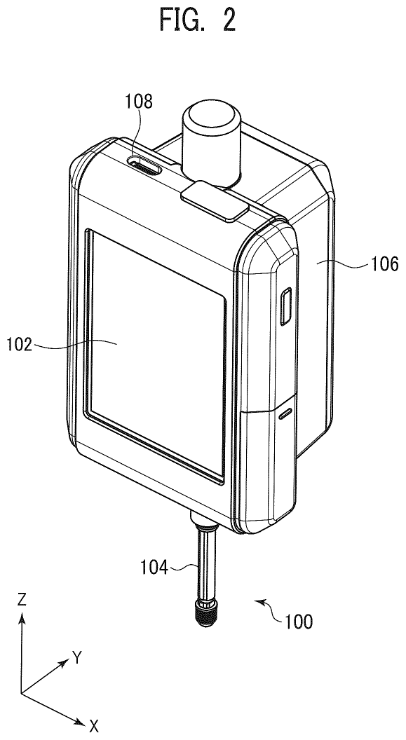

FIG. 1A is a top view of a measuring instrument 100, FIG. 1B is a front view of the measuring instrument 100, and FIG. 1C is a side view of the measuring instrument 100. FIG. 2 is a perspective view of the measuring instrument 100.

The following description is based on the XYZ axes defined as shown in FIGS. 1A to 1C and FIG. 2. The Z-axis direction is vertical, and the X-axis and Y-axis directions are horizontal. The measuring instrument 100 in this embodiment will be described as an indicator gauge.

The measuring instrument 100 is equipped with a telescopic spindle 104. When a workpiece, the object to be measured, is pressed against the spindle 104, the spindle 104 is displaced in the positive Z-axis direction, i.e., in the direction of retraction into the main body. The spindle 104 functions as a “sensor member” for measuring the physical displacement amount.

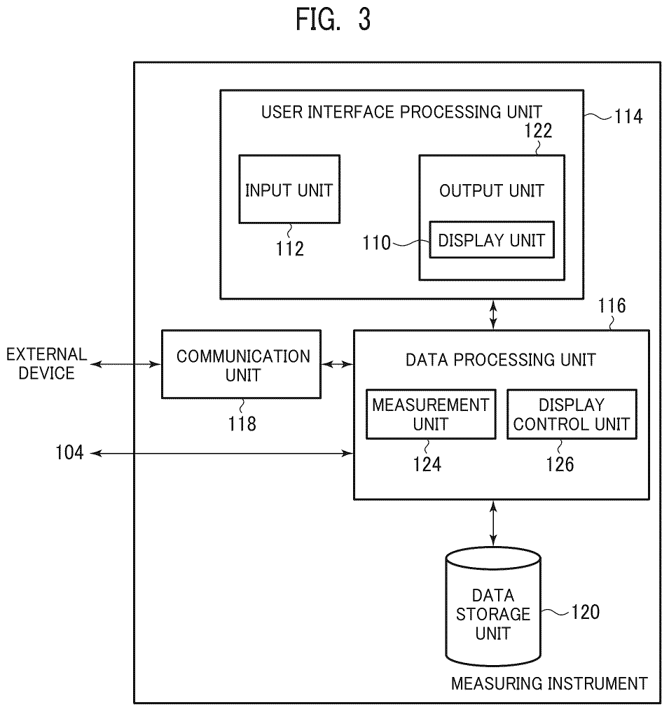

The measuring instrument 100 is equipped with a monitor 102, which is a full-color LCD (Liquid Crystal Display). The measurement values are displayed on the monitor 102. The monitor 102 corresponds to the display unit 110 in FIG. 3. A touch panel is provided on the surface of the monitor 102, and the user can operate the measuring instrument 100 via the touch panel. This touch panel corresponds to the input unit 112 in FIG. 3.

In FIG. 1B, the spindle 104 is provided on the lower side (second side) of the measuring instrument 100, i.e., below the monitor 102 in FIG. 1B, and a connection terminal 108 is provided on the upper side (first side). The measuring instrument 100 can be connected to external devices via cables by means of the connection terminal 108. The back portion 106 houses a rechargeable battery, not shown.

The measuring instrument 100 can communicate with external devices via Bluetooth (registered trademark). The measuring instrument 100 also has a USB (Universal Serial Bus) terminal and a micro SD card insertion slot. The measuring instrument 100 can store measurement values in a micro SD card. It is also possible to update firmware by using the micro SD card. The body of the measuring instrument 100 is made of resin. The back portion 106 incorporates a steel plate so that the back portion 106 can be attached to a magnet.

FIG. 3 is a functional block diagram of the measuring instrument 100.

The components of the measuring instrument 100 are implemented by hardware including computing units such as central processing units (CPUs) and various co-processors, storage devices such as memories and storages, and wired or wireless communication lines that connect these units and devices, and software that is stored in the storage devices and supplies processing instructions to the computing units. Computer programs may be constituted by device drivers, operating systems, various application programs on upper layers thereof, and a library that provides common functions to these programs. Each of the blocks described below does not represent a hardware block but represents a functional block.

The measuring instrument 100 includes a user interface processing unit 114, a data processing unit 116, a communication unit 118, and a data storage unit 120.

The user interface processing unit 114 receives operations conducted by the user and is responsible for processing related to the user interface, such as image display and audio output. The communication unit 118 is responsible for communication with external devices via Bluetooth (registered trademark) or a cable connected to the connection terminal 108. The data processing unit 116 executes various processes based on data acquired by the user interface processing unit 114 and the communication unit 118 and data stored in the data storage unit 120. The data processing unit 116 also functions as an interface to the user interface processing unit 114, the communication unit 118, and the data storage unit 120. The data storage unit 120 stores various programs and setting data.

The user interface processing unit 114 includes an input unit 112 and an output unit 122.

The input unit 112 receives input from the user via the touch panel on the monitor 102. The output unit 122 includes a display unit 110. The display unit 110 displays various images.

The data processing unit 116 includes a measurement unit 124 and a display control unit 126.

The measurement unit 124 measures the displacement amount, or in other words, the amount of expansion and retraction of the spindle 104. The display control unit 126 generates images and displays the images on the display unit 110.

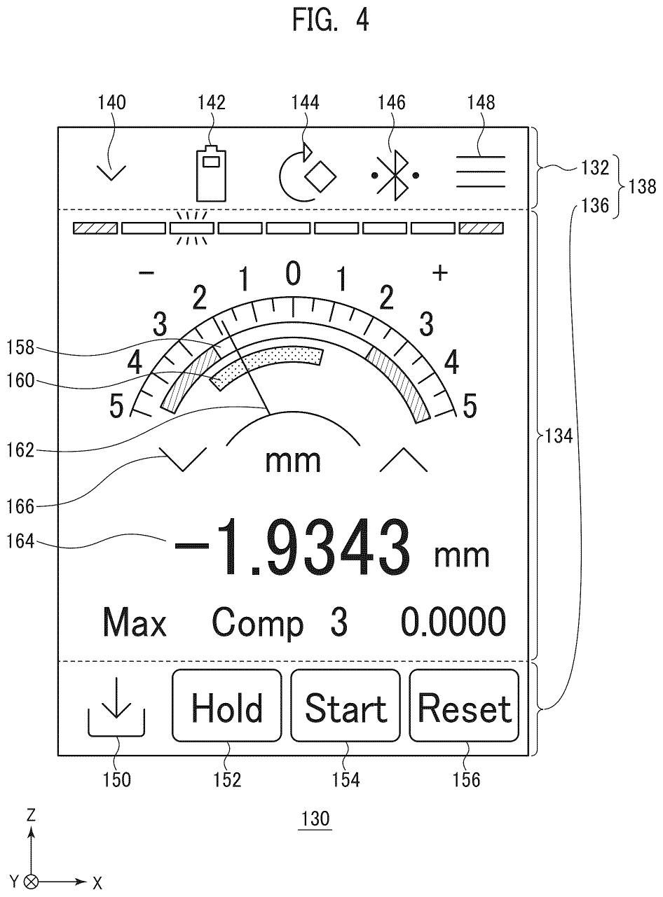

FIG. 4 is a screen view of the first screen 130.

The display control unit 126 displays the first screen 130 on the monitor 102 in the initial state. The downward direction in FIG. 4 is the negative Z-axis direction and the extending direction of the spindle 104. The first screen 130 displayed by the display unit 110 includes an upper area 132, a measurement area 134, and a lower area 136. The measurement area 134 as the first area and an icon area 138 (upper area 132 and lower area 136) as the second area are defined in the display unit 110.

The measurement area 134 displays s an image showing the measurement values. The display control unit 126 develops the images in the image memory and draws the images in the measurement area 134. The measurement area 134 in FIG. 4 displays the displacement amount of the spindle 104 as a measurement value by means of a scale image showing a meter 500 with a scale set and a pointer image showing a pointer 162 superimposed thereon. The pointer image is changed in position according to the displacement amount of the spindle 104 and superimposed on the scale image. Alternatively, the pointer image is processed and displayed so that it is drawn on the scale image. The meter 500 includes a scale indicating the amount of positive and negative displacement of the spindle 104. In the measurement area 134, the pointer image is superimposed on this scale image, and the measurement value is displayed in numerals below the image. The upper area 132 and the lower area 136 are the icon areas 138 for checking the status and operating the measuring instrument 100.

The icon area 138 displays a plurality of icon images (hereinafter referred to simply as “icons”). The display control unit 126 develops the images in the image memory and draws the images in the icon area 138. The icon area 138 displays one of four types of icon images corresponding to the four directions of 0 degrees, 90 degrees, 180 degrees, and 270 degrees. Hereafter, when referring to the icon area 138 corresponding to “0 degrees,” it is written as the icon area 138 (0). The same applies to other angles. In the following, “display direction” means the upward direction when the image is viewed correctly. For example, the display direction of the measurement area 134 in FIG. 4 is the positive Z-axis direction. In the first screen 130, the display direction of the measurement area 134 and the icon area 138 corresponds to the positive Z-axis direction.

As shown in FIG. 4, the first screen 130 is configured as a rectangular image area with the Z-axis direction as the longitudinal direction. The upper area 132 extends in the X-axis direction, and a plurality of icons (extension button 140, battery icon 142, rotation button 144, communication status icon 146, and menu button 148) are arranged along the X-axis direction. Some of the icons function as “control buttons”. The lower area 136 also extends in the X-axis direction, and a plurality of icons (save button 150, hold button 152, start button 154, and reset button 156) are arranged along the X-axis direction.

The measurement area 134 is formed as a square display area in this embodiment. The display control unit 126 visually indicates displacement amount of the spindle 104 from a predetermined reference point by means of the pointer 162. For example, in a case where the reference point is the point where the displacement amount of the spindle 104 is K1, if the displacement amount is equal to K1, the pointer 162 is displayed at a position corresponding to “0,” which is the center of the meter 500. When the displacement amount of the spindle 104 is larger than K1, the pointer 162 is displayed to the right of the center, and when the displacement amount of the spindle 104 is smaller than K1, the pointer 162 is displayed to the left of the center. In FIG. 4, the pointer 162 is displayed to the left of the center, indicating that the displacement amount of the spindle 104 is smaller than K1.

An “effective measurement range” centered on the reference position (displacement amount K1) is defined as the range in which measurement accuracy can be guaranteed. The measurement range meter 158 indicates the distance from the reference position in units of the pointer 162. With the spindle 104 of the measuring instrument 100 pressed against the workpiece, the user may check changes in the measurement value while moving the workpiece. The PP range meter 160 displays the range between the minimum and maximum values in the measurement value change history. The measurement value display area 164 indicates the current measurement value in numerical values. The range (scale) of the meter 500 can be changed by touching the range button 166.

When the extension button 140 in the upper area 132 is touched, the display control unit 126 displays another group of operation buttons (not shown). The battery icon 142 indicates the remaining battery charge. When the rotation button 144 is touched, the display control unit 126 changes the display direction of the screen (see below). The communication status icon 146 indicates the Bluetooth (registered trademark) connection status. When the menu button 148 is touched, a menu screen (not shown) is displayed.

When the save button 150 in the lower area 136 is touched, various data, such as measurement values and settings, are saved. The hold button 152 is a toggle button, and when set to the hold state, the measurement values stop being updated. When the start button 154 is selected, the maximum and minimum measurement values are displayed in real time. The reset button 156 is an operation button for resetting the measurement values. In FIG. 4, the image corresponding to the icon area 138 (0) is displayed.

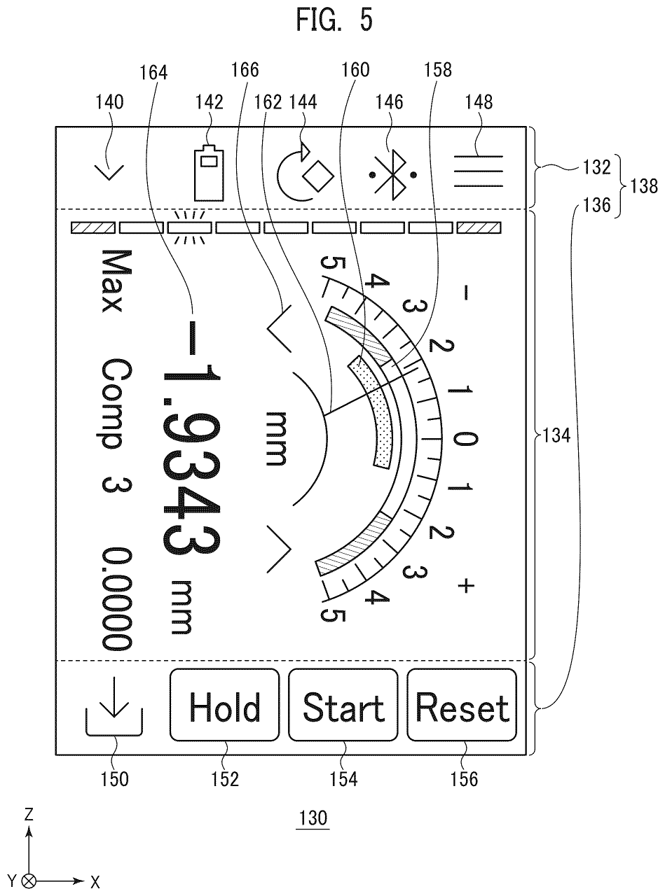

FIG. 5 is an example of a screen view of the second screen.

When the user touches the rotation button 144 once on the first screen 130, the display control unit 126 transitions the screen from the first screen 130 to the second screen 170. In the second screen 170 shown in FIG. 5, only the display direction of the image displayed in the measurement area 134 is rotated by 90 degrees to the right. The displays in the upper area 132 and the lower area 136 remain the same. For example, if an indicator gauge is directed in an orientation in which the spindle of the indicator gauge is horizontal, the measurement values of the indicator gauge are difficult for the user to read. Therefore, to make it easier for the user to read the measurement values of the indicator, image displayed in the measurement area 134 is rotated by 90 degrees to the right. For example, the image display may be changed by changing from the first image to the second image. This process can maintain the visibility of the measurement values to the user.

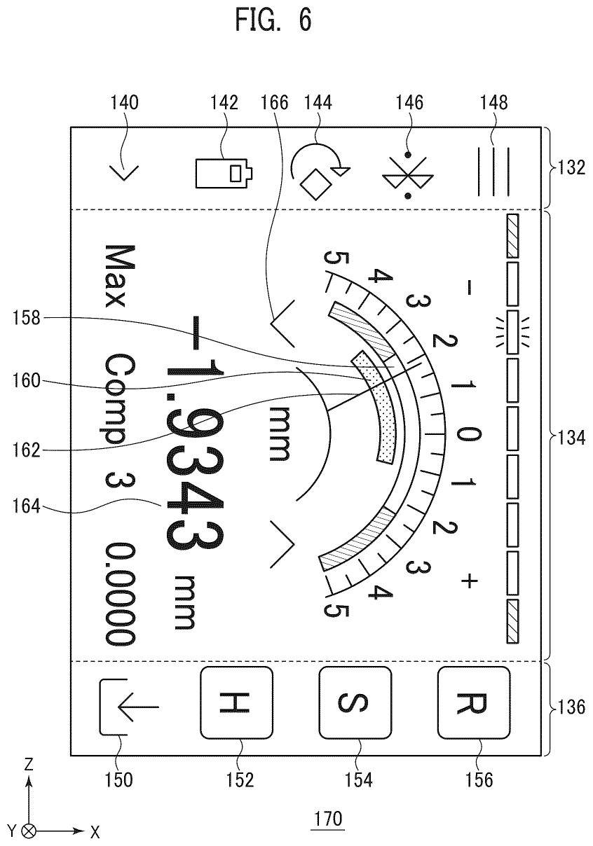

FIG. 6 is another example of a screen view of the second screen 170.

In the other example, when the user touches the rotation button 144 once on the first screen 130, the display control unit 126 transitions the screen from the first screen 130 to the second screen 170. In the second screen 170, the display direction of the measurement area 134 is rotated by 90 degrees to the right. Therefore, the display direction of the measurement area 134 is in the positive X-axis direction.

The measurement area 134 is square in this embodiment, and the first image before the selection of the rotation button 144 (selected by touching in this embodiment) and the second image after the selection are prepared in advance so that when the rotation button 144 is selected, the image corresponding to that rotation angle is displayed. For example, when the first image is displayed on the initial screen with the pointer pointing to 0 on the scale and the measurement value also indicating 0, and the rotation button 144 is touched to change the display, if the state to be displayed is that the pointer points to 0 on the scale and the measurement value indicates 0, the first image may be rotated and displayed without changing the contents. In this case, although the first image and the second image are the same image, this process is also referred to as “the process of drawing the second image” in this specification. As will be described in detail later, when the user rotates the main body of the measuring instrument 100 by 90 degrees to the left, the visibility of the measurement values can be maintained by switching from the first screen 130 to the second screen 170.

As with the icon area 138, in the measurement area 134, four types of images corresponding to the four directions of 0, 90, 180, and 270 degrees may be prepared, and the display control unit 126 may select one of the images according to the rotation angle and then change the image according to the measurement values.

By fixing the display position of the upper area 132 and the lower area 136 to the short side of the monitor 102, sufficient space can be provided for the measurement area 134 in the second screen 170.

In FIG. 6, the image corresponding to the icon area 138 (90) is displayed. The direction of the icon arrangement in the upper area 132 and the lower area 136 is maintained in the X-axis direction in the second screen 170. Thus, in the first screen 130 and the second screen 170, the direction of the icon array remains in the X-axis direction so that operability can be maintained before and after rotation. In the second screen 170, the display direction of the icons themselves is rotated by 90 degrees, as is the measurement area 134. For example, the battery symbol of the battery icon 142 is displayed in the positive Z-axis direction in the first screen 130, but in the second screen 170, the battery symbol of the battery icon 142 is displayed in the positive X-axis direction. The display direction of the icon in the icon area 138 (90) may be changed as it is rotated, or the display direction may be unchanged.

In addition, some of the icons in the icon area 138 (90) have a different design. For example, the reset button 156 is displayed as “Reset” in the first screen 130, and the same is displayed as “R” in the second screen 170. The display control unit 126 changes the design of the reset button 156 because the width of the reset button 156 becomes narrower when the display direction of the reset button 156 in the second screen 170 is in the positive X-axis direction. This control method can maintain the visibility of the icons even after rotation.

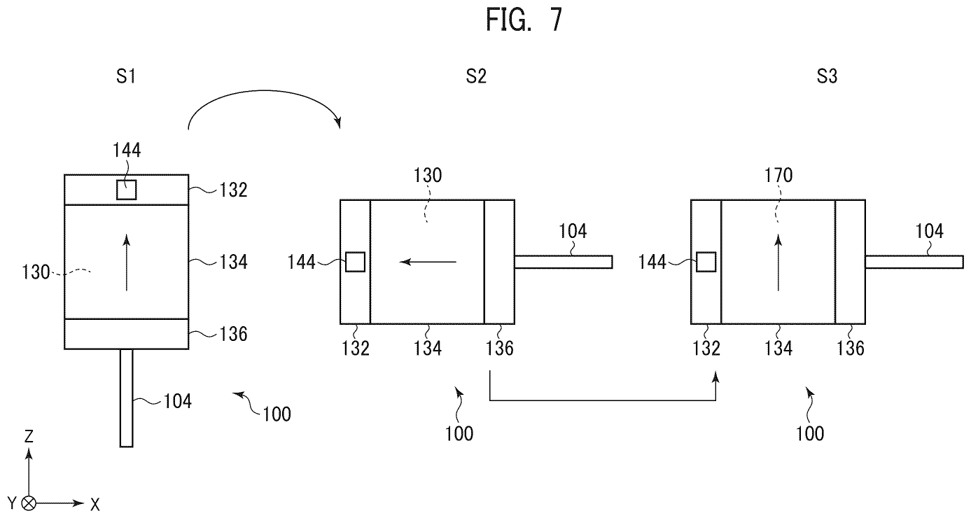

FIG. 7 is a schematic diagram to explain the display switching when the measuring instrument 100 is oriented horizontally.

First, assume that in state S1, with the spindle 104 extending in a vertical direction, the first screen 130 is displayed on the monitor 102. The display direction of the measurement area 134 in this case is in the positive Z-axis direction, with the upper area 132 as the top and the lower area 136 as the bottom.

Assume that the user rotates the main body of the measuring instrument 100 by 90 degrees to the left (state S2). When a workpiece exists on the side of the measuring instrument 100, the spindle 104 is oriented horizontally to measure the workpiece as in state S2. Since the first screen 130 is displayed on the monitor 102, the display direction of the measurement area 134 becomes horizontal, i.e., the negative X-axis direction. Due to the rotation of the main body of the measuring instrument 100, the display direction of the measurement area 134 and other areas is inappropriate.

The user touches the rotation button 144 once in state S2. The display control unit 126 changes the display screen on the monitor 102 from the first screen 130 to the second screen 170. At this time, the display control unit 126 displays the image corresponding to the icon area 138 (180). As explained above, the measurement area 134 is rotated by 90 degrees to the right by touching the rotation button 144 (state S3). Since the second screen 170 is displayed on the monitor 102, the display direction of the measurement area 134 is vertical, i.e., in the positive Z-axis direction. With the display rotation operation, the display direction of the measurement area 134 and other areas becomes appropriate. Thus, the display control unit 126 maintains the display direction of the icon area 138 by selecting one of the four images corresponding to the icon area 138 as the display target each time the rotation button 144 is touched. The display control unit 126 also rotates the display direction of the image corresponding to the measurement area 134 each time the rotation button 144 is touched.

In the display rotation operation from state S2 to state S3, the display direction of the measurement area 134 changes, but the positions of the upper area 132 and the lower area 136 remain unchanged. The direction of the icon array is also unchanged. After the display rotation, the upper area 132 and the lower area 136 are still on the short side of the monitor 102, providing sufficient space for the measurement area 134.

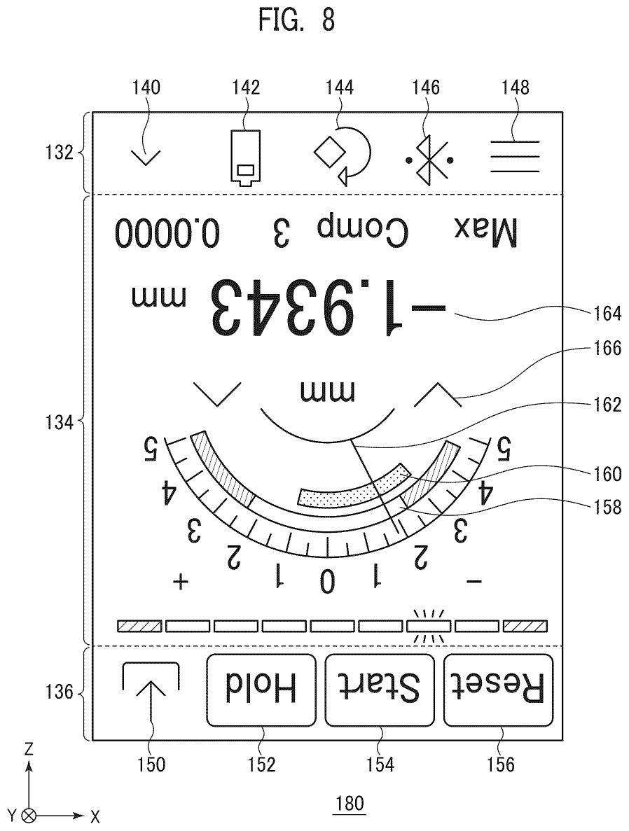

FIG. 8 is a screen view of the third screen 180.

When the user touches the rotation button 144 once in the second screen 170, the display control unit 126 transitions the screen from the second screen 170 to the third screen 180. The display rotation from the second screen 170 to the third screen 180 rotates the measurement area 134 by 90 degrees to the right. As a result, the display direction of the measurement area 134 and the icon area 138 becomes the negative Z-axis direction. In other words, the display direction of the measurement area 134 on the third screen 180 is opposite to the direction of the measurement area 134 on the first screen 130.

In the third screen 180, the array direction of the icons is maintained in the X-axis direction. Although not shown in the figure, when the user touches the rotation button 144 further in the third screen 180, the display control unit 126 rotates the measurement area 134 by 90 degrees to the right. When the user touches the rotation button 144 one more time, the display control unit 126 displays the first screen 130. In other words, when the user touches the rotation button 144 four times, the measurement area 134 is rotated one revolution.

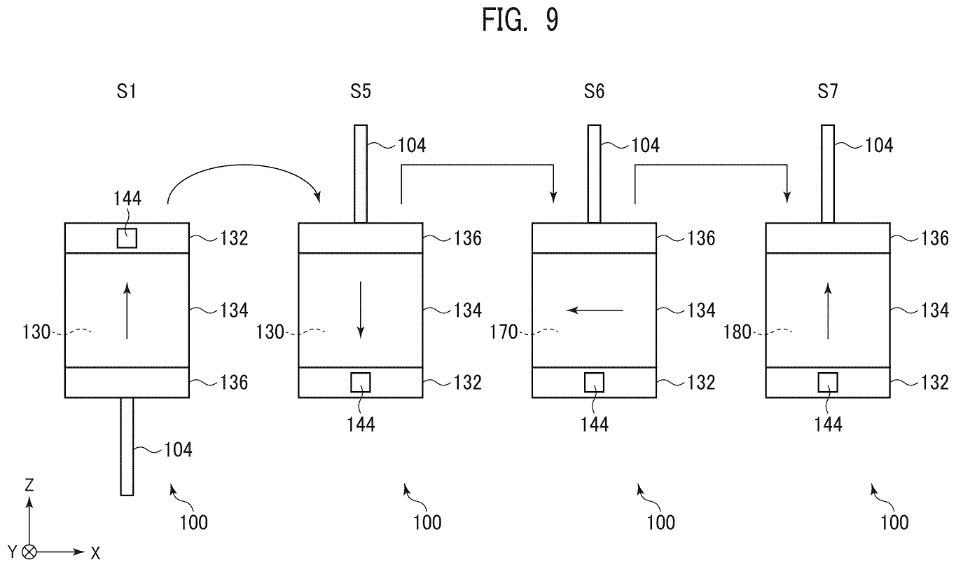

FIG. 9 is a schematic diagram to illustrate the display switching when the measuring instrument 100 is turned upside down.

First, in state S1, with the spindle 104 extending in a vertical direction, the first screen 130 is displayed on the monitor 102.

Now, suppose that the user has rotated the main body of the measuring instrument 100 by 180 degrees (state S5). When a workpiece is located in the upper direction of the measuring instrument 100, the measuring instrument 100 is turned in the opposite direction, as in state S5. Since the first screen 130 is displayed on the monitor 102, the display direction of the measurement area 134 is in a vertical downward direction, i.e., the negative Z-axis direction. In state S5, the display direction of the measurement area 134 and other areas is inappropriate.

In state S5, the user touches the rotation button 144 once. The display control unit 126 changes the first screen 130 to the second screen 170. With the first touch of the rotation button 144, the measurement area 134 is rotated by 90 degrees to the right (state S6). Since the second screen 170 is displayed on the monitor 102, the display direction of the measurement area 134 becomes horizontal, i.e., the negative X-axis direction. The position of the rotation button 144 has not changed when changed from state S5 to state S6. In state S6, the display direction of the measurement area 134 and other areas is inappropriate.

In state S6, the user further touches the rotation button 144 once. The display control unit 126 changes the display image from the second screen 170 to the third screen 180. The measurement area 134 is rotated by 90 degrees to the right (state S7). The third screen 180 is displayed on the monitor 102, and the display direction of the measurement area 134 becomes the positive vertical direction, i.e., the positive Z-axis direction. With the two display rotation operations, the display direction of the measurement area 134, among others, becomes appropriate.

In the two display rotation operations from state S5 to state S7, the display direction of the measurement area 134 changes, but the display positions of the upper area 132 and the lower area 136 are unchanged. The arrangement of the operation buttons and icons is also unchanged.

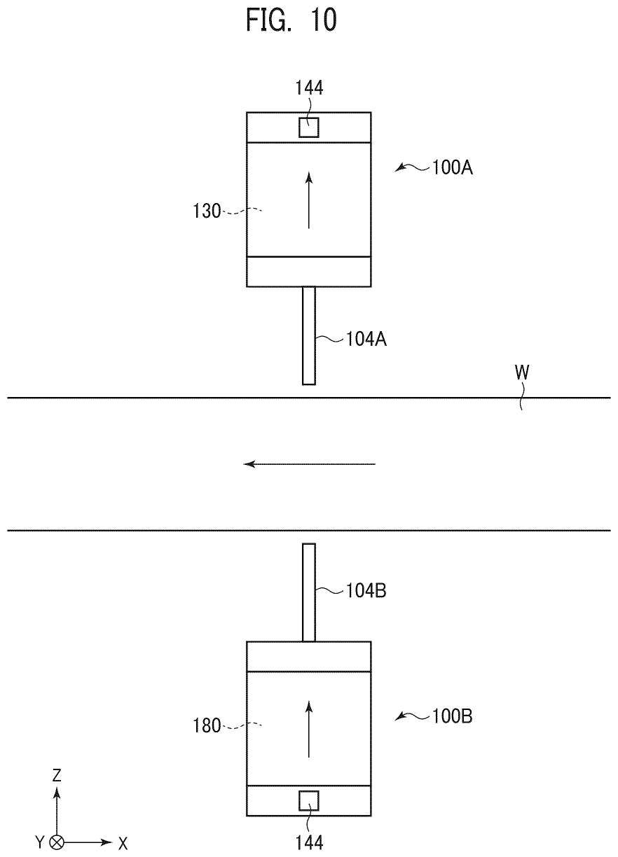

FIG. 10 is a schematic diagram showing an example of the arrangement of the two measuring instruments 100 when measuring the flatness of a workpiece.

In FIG. 10, the measuring instrument 100A and the measuring instrument 100B are fixed. The spindle 104A of the measuring instrument 100A and the spindle 104B of the measuring instrument 100B are placed facing each other, and a workpiece W is moved horizontally into the gap between the spindles 104A and 104B. With this movement, the spindles 104A and 104B expand and retract in the Z-axis direction (vertical direction) according to the unevenness of the surface of the workpiece W so that the flatness of the surface of the workpiece W can be obtained from the measurement values of the measuring instrument 100A and the measuring instrument 100B.

For the measuring instrument 100A, since the spindle 104A extends in the negative Z-axis direction, the user can appropriately view the measurement values if the first screen 130 (state S1) is displayed. For measuring instrument 100B, since the spindle 104B extends in the positive Z-axis direction, the user can appropriately view the measurement values if the third screen 180 (state S7) is displayed.

### SUMMARY

The measuring instrument 100 has been described above based on the embodiment.

According to the measuring instrument 100, the display image on the monitor 102 can be controlled so that the direction of the display image on the monitor 102 is easy for the user to view, i.e., the display direction of the measurement area 134, among others, is vertically upward, depending on the orientation of the spindle 104. The user can rotate the measurement area 134 by 90 degrees each time the rotation button 144 is touched. Unlike in Patent Literature 1, since the rotation button 144 is always displayed in the upper area 132, the user can easily set the display direction of the measurement area 134 to the desired direction by continuously touching the rotation button 144.

The measurement area 134 is displayed in the center of the monitor 102, and the upper area 132 and the lower area 136 extend along the two short sides of the monitor 102. The positions of the icons displayed in the upper area 132 and the lower area 136 are maintained before and after rotation. The display direction of the icons is rotated in the same manner as the measurement area 134. Thus, by touching the rotation button 144 to rotate the screen, the display direction of the upper area 132, the measurement area 134, and the lower area 136 is appropriately changed, while the positions of the icons before and after rotation are maintained, thereby achieving both visibility and operability.

The present invention is not limited to the embodiment t described above and modifications thereof, and any component thereof can be modified and embodied without departing from the scope of the invention. Components described in the embodiment and modifications can be combined as appropriate to form various embodiments. Some components may be omitted from the components presented in the embodiment and modifications.

### Modifications

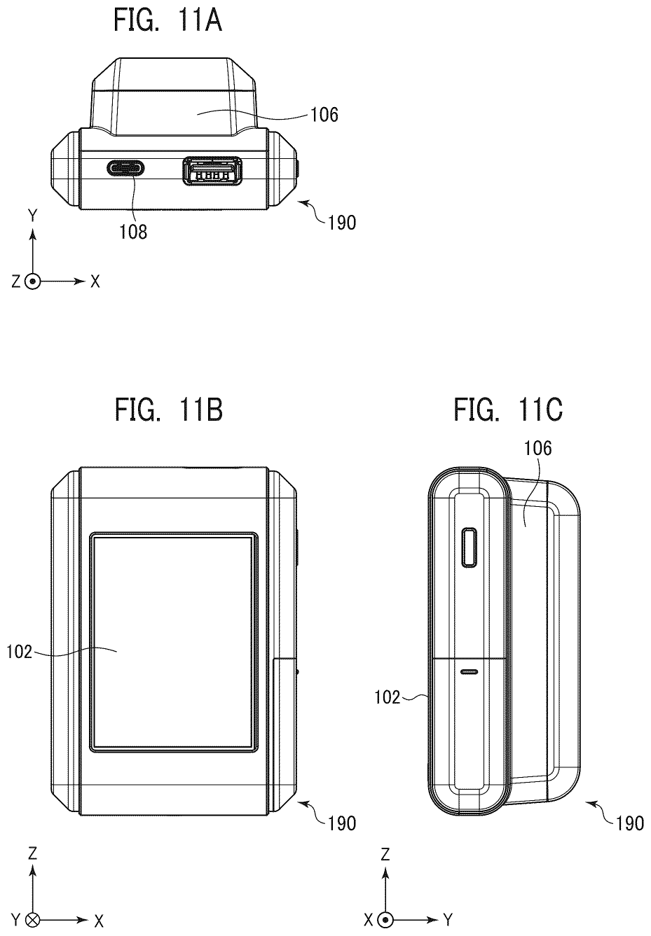

FIG. 11A is a top view of a display device 190, FIG. 11B is a front view of the display device 190, and FIG. 11C is a side view of the display device 190.

The display device 190 is a device with the spindle 104 removed from the measuring instrument 100. The display device 190 is connected to other measuring instruments, such as indicator gauges or lever gauges, and displays their measurement results on the monitor 102. The display device 190 is basically the same as the measuring instrument 100, except that it does not include the spindle 104 and the measurement unit 124. The display control unit 126 of the display device 190 generates a display screen for the monitor 102 based on the measurement data obtained from the external measuring instrument. The display device 190 can be oriented in any direction. The user can rotate the display direction of the measurement area 134 in the same manner as the measuring instrument 100 by touching the rotation button 144 displayed on the monitor 102.

The measuring instrument 100 or the display device 190 may be equipped with a gyro sensor. The display control unit 126 may identify the orientation of the measuring instrument 100 and automatically set the display direction of the image according to the detection by the gyro sensor. For example, when the measuring instrument 100 is in state S1 (see FIG. 6), the display control unit 126 displays the first screen 130 on the monitor 102. When the measuring instrument 100 is in state S5 (see FIG. 8), the display control unit 126 may display the third screen 180 on the monitor 102.

This application claims priority from Japanese Patent Application No. 2022-143588 filed on Sep. 9, 2022, the entire contents of which are hereby incorporated by reference herein.

1. A display device for displaying measurement values, comprising:
a display unit with a touch panel having a first area for displaying measurement values and a second area for displaying a plurality of icons; and
a display control unit that controls the display of images to be displayed on the display unit, wherein
the display control unit performs the controls of (i) displaying, on the display unit, a first image including the measurement values in the first area and an icon image of a rotation button in the second area, and (ii) when the rotation button is touched, drawing a second image including a representation of the measurement values corresponding to a state in which the measurement values in the first image are rotated in the first region.

2. The display device according to claim 1, wherein
when the rotation button is touched, the display control unit performs at least one of the controls of (i) maintaining the display direction of the icon image in the second area, (ii) changing the display direction of the icon image in the second area, and (iii) changing the design of the icon image in the second area.

3. The display device according to claim 1, further comprising:
a connection terminal for a cable, wherein
the display control unit displays in the first area a measurement value obtained from an external measuring instrument connected via the cable.

4. The display device according to claim 1, wherein
the display unit is formed in a rectangular shape,
the second area is an area extending to the short side of the display unit, and
the plurality of icons are arranged along the extending direction of the second area.

5. A measuring instrument, comprising:
the display device according to claim 1;
a connection terminal for a cable; and
a sensor member that changes position in response to contact with an object to be measured, wherein
the connection terminal is formed on a first side of the display unit, and
the sensor member is formed on a second side of the display unit opposite the first side of the display unit.

6. The measuring instrument according to claim 5, wherein
in a state in which the extending direction of the sensor member is a vertical direction and the display direction of the first area and the second area are both the vertical direction,
when a user changes the orientation of the device so that the extension direction of the sensor member is a horizontal direction, thereby changing the display direction of the first and second areas to the horizontal direction, and then touches the rotation button,
the display control unit changes the display direction of the first area to the vertical direction.
